(19) United States
(12) Patent Application Publication
(10) Pub. No.: US 2007/0147808 A1
(43) Pub. Date: Jun. 28, 2007

(54) Flow trough sauna steamer with manifold

(76) Inventor: Zoltan Egeresi, Santa Cruz, CA (US)

Correspondence Address: ZOLTAN EGERESI, 5500. COAST Rd., SANTA CRUZ, CA, 95060, US

(21) Appl. No.: 11/320,044

(22) Filed: Dec. 28, 2005

(51) Int. Cl. H05B 3/78

(52) U.S. Cl. 392/485

(57) ABSTRACT

My invention is a tank-less, a flow trough electric steamer, which does not need any plumbing or electrical installation. This Low Cost Flow Trough Sauna Steamer with Manifold is easy to install, easy to operate, it uses a diverter from a faucet or shower head as a water source and 110V or 220 V electricity 15-20 A plug outlet. Additional benefits are: instant on demand steam, low operating cost, with slow water flow it functions as a steam generator, with higher volume it is a flow trough water heater for a shower or sink. The steam manifold is a space saver rigid material with small steam venting holes insertable between the sliding door or it can be attached to the top of the bath tub. At least one steam-venting hole has an extended flexible hose connecting into a small cup holding herbs or mineral oil.

### BACKGROUND OF THE INVENTION

Prior arts of steam generators for sauna are mostly based on closed, pressurized water system using a smaller storage/boiling tank, generally they are expensive, some take up lot space and in most cases require electrical and plumbing installation. My invention is a tank-less, a flow trough electric steamer, which does not need any plumbing or electrical installation. This Low Cost Flow Trough Sauna Steamer with Manifold is easy to install, easy to operate, it uses a diverter from a faucet or shower head as a water source and 110V or 220 V electricity 15-20 A plug outlet.

My invention, the Flow Trough Sauna Steamer with Manifold generates sufficient steam for an average size shower/bathtub area as a converted, enclosed sauna space. Most prior art steamers require special plumbing and hard-wired electrical installation, usually providing larger steam generating capacity, making the sauna installation more expensive. My invention does not need any dedicated plumbing or electrical installation, therefore it becomes more affordable to a larger segment of the population.

This invention may be portable or a fixed steaming apparatus, water for the steamer is provided from a sink or shower diverter, steam is communicated to the enclosed sauna area trough a steamer manifold, insertable between the shower door and the wall. With higher water flow this invention works as an open ended flow trough low volume water heater.

### BRIEF SUMMARY OF THE INVENTION

This sauna flow trough steam generator uses a rigid pipe vertically positioned where at the bottom end an electrical heating element can be inserted, at top end it is open to let the steam flow out to the steam manifold. Diverted sink or showerhead water flows into the heater chamber trough solenoid which is activated by the water level switch. Thermostat located above the heater element shots off the electricity in case no water or excessive heat is present (over 110-115 C). High water level shuts off water flow solenoid, excess water can exit at the overflow/hot water pipe, for periodical cleaning, rinsing draining valve is provided at the bottom. Steam manifold attaches to the attaches between the shower sliding door and door frame, at least one flexible steam venting hose communicates steam to an attachable cup holding mineral oils or herbs. U.S. Pat. No. 6,577,815 by Wu shows a smaller steam generator, but it uses a water tank, requiring fixed plumbing. U.S. Pat. No. 4,459,465 by Knight is essentially an on demand multi chamber water heater for a closed, pressured water system where this prior art is design to shot off before boiling point to prevent pipe explosion due to steam generation. U.S. Pat. No. 6,745,412 B1 by Egeresi is steamer using a smaller tank with an herb tray converting a bath room or shower area to a sauna.

### BRIEF DESCRIPTION OF THE INVENTION

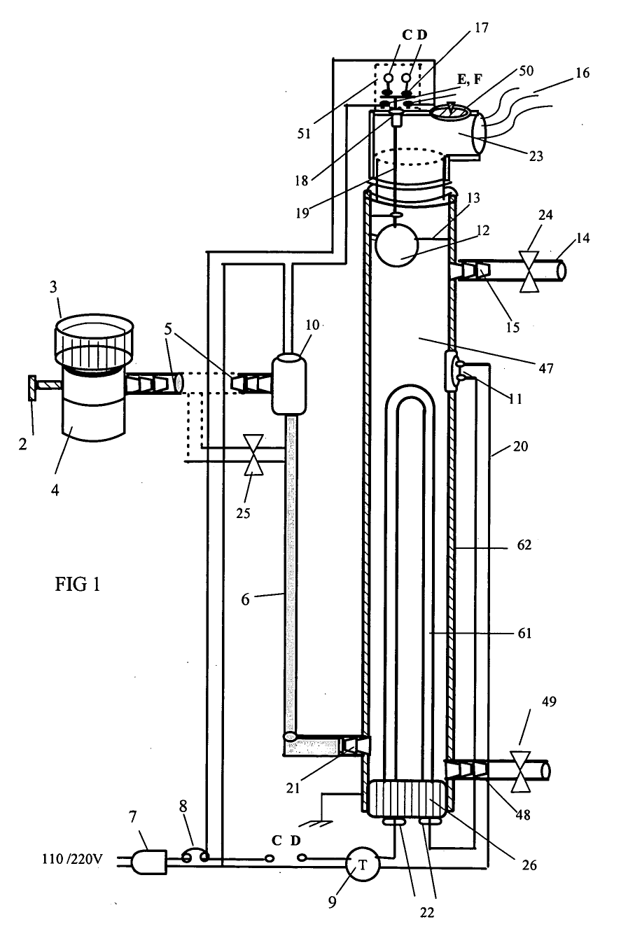

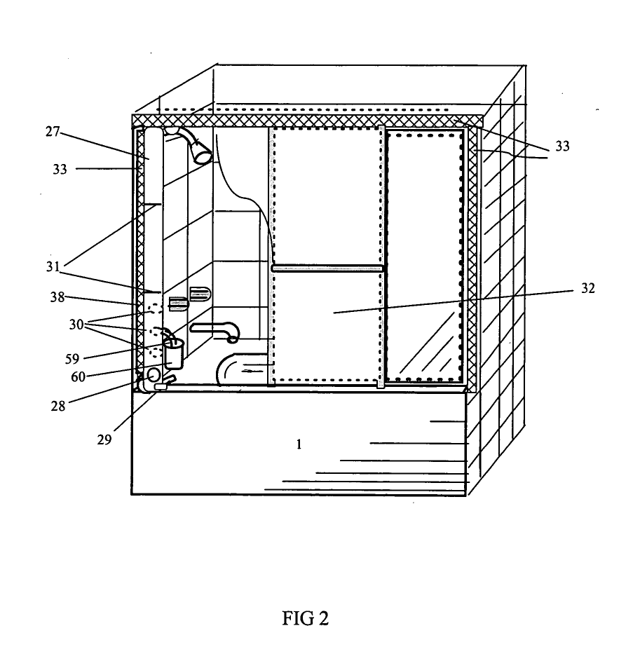

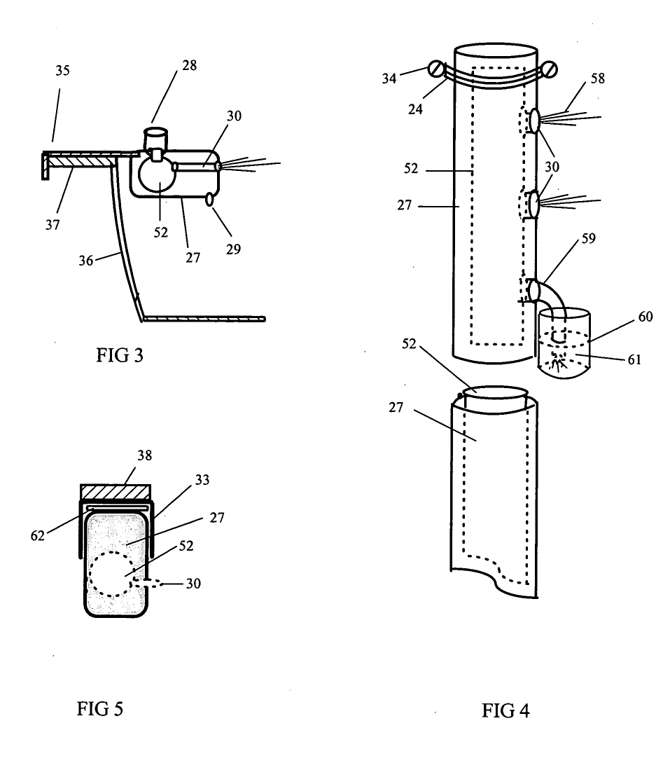

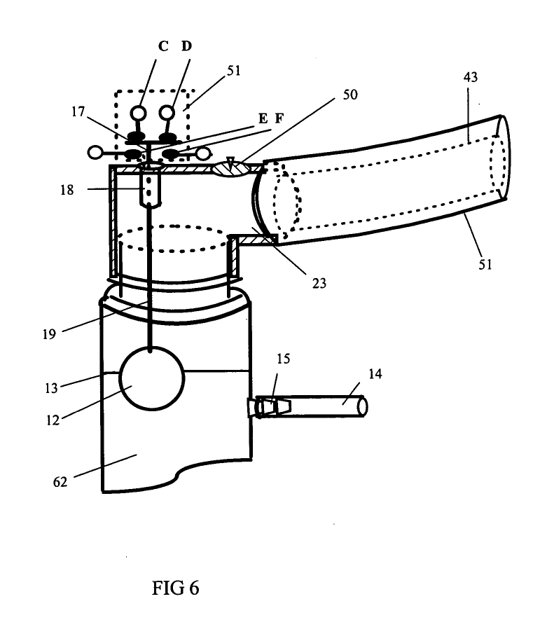

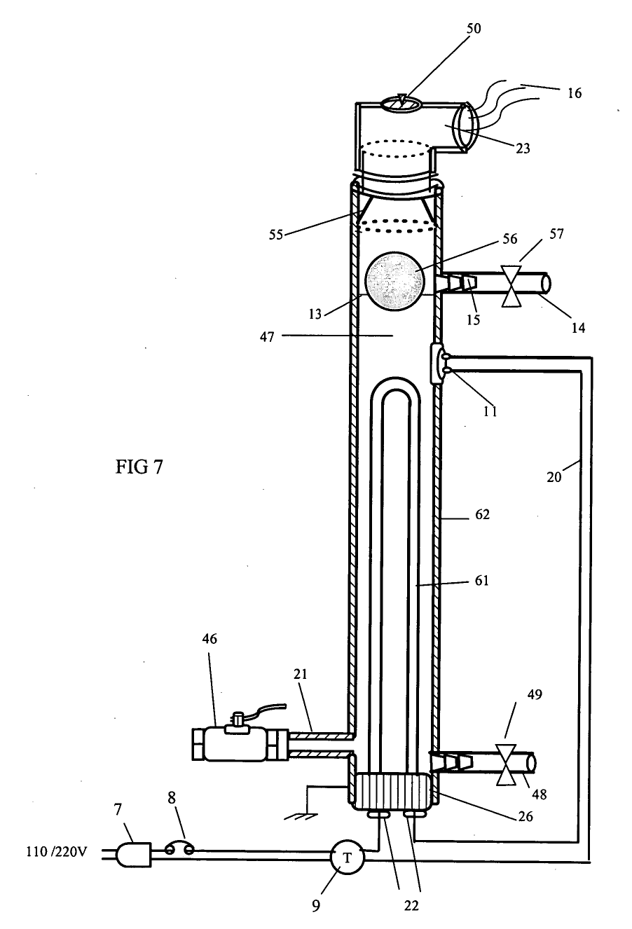

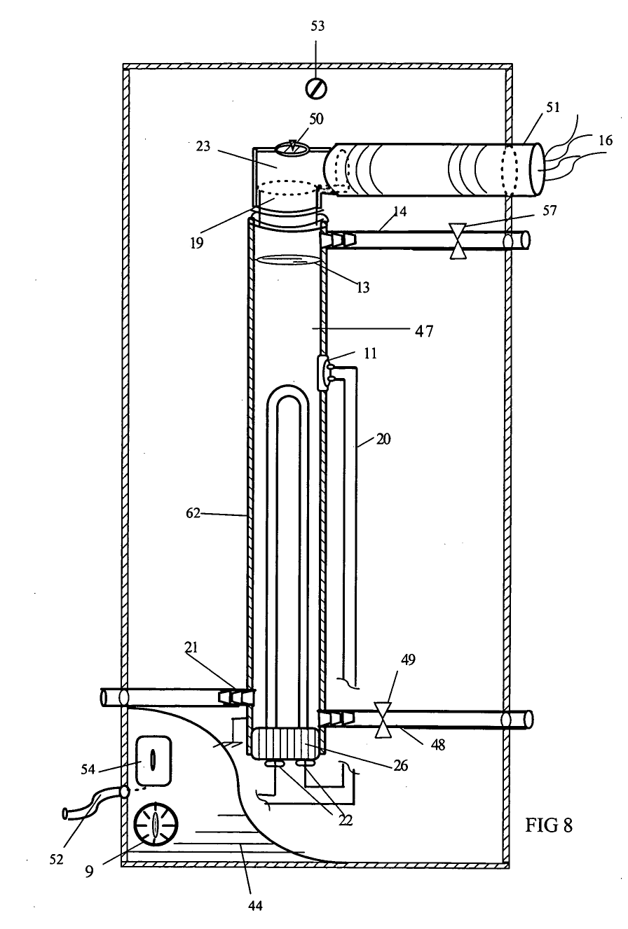

FIG. 1 sheet 1 shows the selected flow trough automated steamer. Steamer (62) is the water container with heating element (61) 1,000-4,500 Watts, bringing the water in the container (62) to boiling point. Water is flowing from diverter (4) trough solenoid (10) into the Flow Through Steamer. Water level floater (12) turns on the heater contacts (22) bringing the water to boiling point. Thermostat (11) set to prevent overheating. Steam exits at hose connection (23), if water volume is increased, outflow at (14) provides low volume hot water for shower. FIG. 6 sheet 4 shows a close up view of the upper section of the water level/heater control switch (51) activated by floater (12). FIG. 7 on sheet 5 shows the manually controlled version of the water Flow Through Steamer with a floating ball (56). Slow water flow allows steam generation by floating the ball, faster water flow positions the ball in the upper cone, forcing hot water out at connection (15). FIG. 8 on sheet 6 shows the Flow Trough Steamer only unit in a box. FIG. 2 on sheet 2 shows a standard shower enclosure (1) with a vertically inserted steam manifold (27). FIG. 4 on sheet 3 shows the detachable, multi part steamer manifold (27) with steam vent Outlets (30), with an herbal/mineral oil cup (60), where the steam extracts the aroma. FIG. 3 Sheet 3 shows the steamer manifold (27) attached to the side of the bath tub (36). FIG. 5 shows the top view of the steamer manifold (27) with the inside hose communicating the steam for safety inserted into the frame of the shower door (33).

### DETAILED DESCRIPTION OF THE INVENTION

FIG. 1 sheet 1 shows the selected Flow Trough automated Steamer. Steamer (62) is the water container rigid, heat and corrosion resistant material with heating element (61) threaded into the bottom (26)1,000-4,500 Watts, capable of bringing the water in the container (62) to boiling point. Water is flowing from diverter (4) which is connected to the bathroom sink by threads (3) (or to the shower) by turning on diverter knob (2) as water flows to the solenoid (10) trough flexible hose (5), than communicates the water to the lower section of the steamer at connection (21). When the chamber(47) is empty, floating switch ball (12) is in the lower position enabling E and F switch contacts (17) of switch (51) to be closed, energizing solenoid (10). Floater shaft (19) is guided trough pinhole (18) on the top of the steamer chamber (23). When steamer chamber (62) is full of water, water reaches high level at (13), it deactivates the solenoid water level sensor E and F therefore stopping the water flow. In full water level A and B contacts are closed allowing the current to flow from AC connector (7), trough fuse (8), timer (9) to heater connection (22) via thermostat (11). The function of the thermostat is to cut off the AC current in case of no water or over heating condition occurs. Connection (15) is the hot water outlet when valve (24) is opened connecting to hose (14), which may be a shower on/off knob.

This valve (24) acts also as a temperature control in the Flow Trough Water Heater mode, by adjusting the volume at a steady water pressure. Higher water volume passing trough the steamer prevents steam formation, by keeping water level in high level as heater contacts remain closed. To maintain steady water flow water solenoid bypass valve (25) should be in the open position.

At the bottom of the steam chamber is the drainage outlet (62) with valve outlet (49), on the top opening (25) allows the introduction mineral deposit cleaning chemicals. The steam opening is on the top (50) at the front end of steamer cap (23), steam is (16). Sheet 4 FIG. 6 shows a close up of the upper portion of the steam chamber (62) as the floater rod (19) is moving up and down in the guide tube (43).

Flexible hose (51) conducts the steam within the internal tube (43) as a heath shield. Sheet 5 FIG. 7 is the manual version of the Flow Trough Steamer where the water is introduced and flow is controlled manually by valve (46) as it communicates the flow via pipe connector (21). Slow water flow allows the heater (61) to bring and maintain the water slightly above boiling temperature for producing non stop, on demand steam.

Floating ball (56) floats around the hot water outflow valve (15) during steam production, water level is marked (13).

On demand Water heater mode is achieved by increasing water flow to lift up the floating ball (13) into cone (55) to close off steam exit. At this time hot water/shower outlet (15) with valve 57 should be open, as volume sets up the actual temperature.

The electronic parts are AC plug (7), fuse (8) connecting to Timer (9) to the heating element via thermostat (11) to prevent over heating condition.

Sheet 6 FIG. 8 shows the basic Flow Trough Steamer in a box (44) with timer (9), on off switch (54), AC cable (52) fastening screw (53).

Sheet 2 FIG. 2 shows a standard bathtub (1) with shower sliding door (32), frame (33) attached to wall (38). Inside the sliding door frame (33) the multi piece steam manifold (27) is inserted, also shown on Sheet 3 FIG. 5 top view.

Steam enters into the manifold at location (28) and exits at steam vents (30). At least one of the vent has a flexible hose (59) connected to a smaller cup (60) capable of holding mineral oils or herb (61), tea bags to provide a healthier steam, also shown on sheet 3 FIG. 4. FIG. 2 also shows separation of manifold (31) which is cut to the same height as the sliding door in order to provide a good closure. At the bottom condensed water outflow (29) is located. Sheet 3 FIG. 5 shows a top view of the inserted manifold attached to the frame with Velcro (62), inside the manifold (27) is the center steam conductor (52) to prevent accidental scolding, steam vents are (30).

FIG. 3 shows a horizontal manifold (27) mounting as an example on the side of the bath tub (36,37). Steam inflow (28), out (30), bracket (35) holding the manifold.

FIG. 4 also shows a detachable dual chamber manifold, oval shape, with fasteners (34, 24), steam (58), and herb/mineral oil (61) cup (60)

### BACKGROUND OF THE INVENTION

Prior arts of steam generators for sauna are mostly based on closed, pressurized water system using a smaller storage/boiling tank, generally they are expensive, some take up lot space and in most cases require electrical and plumbing installation. My invention is a tank-less, a flow trough electric steamer, which does not need any plumbing or electrical installation. This Low Cost Flow Trough Sauna Steamer with Manifold is easy to install, easy to operate, it uses a diverter from a faucet or shower head as a water source and 110V or 220 V electricity 15-20 A plug outlet.

My invention, the Flow Trough Sauna Steamer with Manifold generates sufficient steam for an average size shower/bathtub area as a converted, enclosed sauna space. Most prior art steamers require special plumbing and hard-wired electrical installation, usually providing larger steam generating capacity, making the sauna installation more expensive. My invention does not need any dedicated plumbing or electrical installation, therefore it becomes more affordable to a larger segment of the population.

This invention may be portable or could be used as a fixed steaming apparatus, water for the steamer is provided from a sink or shower diverter, steam is communicated to the enclosed sauna area trough a steamer manifold, insertable between the shower door and the wall. With increased volume (higher) of water flow this invention works as an open ended flow trough low volume water heater.

### BRIEF SUMMARY OF THE INVENTION

This sauna flow trough steam generator uses a rigid pipe vertically positioned where at the bottom end an electrical heating element can be inserted, at top end it is open to let the steam flow out to the steam manifold. Diverted sink or showerhead water flows into the heater chamber trough solenoid which is activated by the water level switch. Thermostat located above the heater element shots off the electricity in case no water or excessive heat is present (over 110-115 C). High water level shuts off water flow solenoid, excess water can exit at the overflow/hot water pipe, for periodical cleaning, rinsing draining valve is provided at the bottom. Steam manifold attaches to the attaches between the shower sliding door and door frame, at least one flexible steam venting hose communicates steam to an attachable cup holding mineral oils or herbs. The primary objection of this invention is to create a low cost steamer for indoor sauna in an enclosed area or outdoor by a Jacuzzi as a dual function steamer/hot water heater heater for a shower.

### BRIEF DESCRIPTION OF THE INVENTION

Sheet 1 of 6 FIG. 1 shows the elected flow trough automated steamer. Steamer (62) is the water container with heating element (61) 1,000-4,500 Watts, bringing the water in the container (62) to boiling point. Water is flowing from diverter (4) trough solenoid (10) into the Flow Through Steamer. Water level floater (12) turns on the heater contacts (22) bringing the water to boiling point. Thermostat (11) set to prevent overheating. Steam exits at hose connection (23), if water volume is increased it will decrease the temperature, therefore outflow at (14) provides low volume hot water for shower. Sheet 2 of 6 FIG. 2 on shows a standard shower enclosure (1) with a vertically inserted steam manifold (27) with herb/mineral oil cup (60).

Sheet 3 of 6 FIG. 3, FIG. 4 shows the steamer manifold (27) as a dependent claim attached to the side of the bath tub (36) or to the side wall (38) or it could be on the floor. Sheet 3 FIG. 4 shows the detachable, multi part steamer manifold (27) with steam vent outlets (30), with an herbal/mineral oil cup (60), where the steam extracts the aroma. FIG. 5 shows the side view of the detachable steamer manifold (27) with the inside tube communicating the steam for safety inserted into the frame of the shower door (33).

Sheet 4 of 6 FIG. 6 shows a close up view of the upper section of the water level/heater control switch (51) activated by floater (12).

Sheet 5 of 6 FIG. 7 shows the manually controlled version of the water Flow Through Steamer with a floating ball (56). Slow water flow allows steam generation by floating the ball, faster water flow positions the ball in the upper cone, forcing hot water out at connection (15). Sheet 6 FIG. 8 on shows the Flow Trough Steamer only unit in a box.

### BACKGROUND OF THE INVENTION

Prior arts of steam generators for sauna are mostly based on closed, pressurized water system using a smaller storage/boiling tank, generally they are expensive, some take up lot space and in most cases require electrical and plumbing installation. My invention is a tank-less, a flow trough electric steamer, which does not need any plumbing or electrical installation. This Low Cost Flow Trough Sauna Steamer with Manifold is easy to install, easy to operate, it uses a diverter from a faucet or shower head as a water source and 110V or 220 V electricity 15-20 A plug outlet.

My invention, the Flow Trough Sauna Steamer with Manifold generates sufficient steam for an average size shower/bathtub area as a converted, enclosed sauna space. Most prior art steamers require special plumbing and hard-wired electrical installation, usually providing larger steam generating capacity, making the sauna installation more expensive. My invention does not need any dedicated plumbing or electrical installation, therefore it becomes more affordable to a larger segment of the population.

This invention may be portable or a fixed steaming apparatus, water for the steamer is provided from a sink or shower diverter, steam is communicated to the enclosed sauna area trough a steamer manifold, insertable between the shower door and the wall. With higher water flow this invention works as an open ended flow trough low volume water heater.

### BRIEF SUMMARY OF THE INVENTION

This sauna flow trough steam generator uses a rigid pipe vertically positioned where at the bottom end an electrical heating element can be inserted, at top end it is open to let the steam flow out to the steam manifold. Diverted sink or showerhead water flows into the heater chamber trough solenoid which is activated by the water level switch. Thermostat located above the heater element shots off the electricity in case no water or excessive heat is present (over 110-115 C). High water level shuts off water flow solenoid, excess water can exit at the overflow/hot water pipe, for periodical cleaning, rinsing draining valve is provided at the bottom. Steam manifold attaches to the attaches between the shower sliding door and door frame, at least one flexible steam venting hose communicates steam to an attachable cup holding mineral oils or herbs. U.S. Pat. No. 6,577,815 by Wu shows a smaller steam generator, but it uses a water tank, requiring fixed plumbing. U.S. Pat. No. 4,459,465 by Knight is essentially an on demand multi chamber water heater for a closed, pressured water system where this prior art is design to shot off before boiling point to prevent pipe explosion due to steam generation. U.S. Pat. No. 6,745,412 B1 by Egeresi is steamer using a smaller tank with an herb tray converting a bath room or shower area to a sauna.

### BRIEF DESCRIPTION OF THE INVENTION

FIG. 1 sheet 1 shows the selected flow trough automated steamer. Steamer (62) is the water container with heating element (61) 1,000-4,500 Watts, bringing the water in the container (62) to boiling point. Water is flowing from diverter (4) trough solenoid (10) into the Flow Through Steamer. Water level floater (12) turns on the heater contacts (22) bringing the water to boiling point. Thermostat (11) set to prevent overheating. Steam exits at hose connection (23), if water volume is increased, outflow at (14) provides low volume hot water for shower. FIG. 6 sheet 4 shows a close up view of the upper section of the water level/heater control switch (51) activated by floater (12). FIG. 7 on sheet 5 shows the manually controlled version of the water Flow Through Steamer with a floating ball (56). Slow water flow allows steam generation by floating the ball, faster water flow positions the ball in the upper cone, forcing hot water out at connection (15). FIG. 8 on sheet 6 shows the Flow Trough Steamer only unit in a box. FIG. 2 on sheet 2 shows a standard shower enclosure (1) with a vertically inserted steam manifold (27). FIG. 4 on sheet 3 shows the detachable, multi part steamer manifold (27) with steam vent Outlets (30), with an herbal/mineral oil cup (60), where the steam extracts the aroma. FIG. 3 Sheet 3 shows the steamer manifold (27) attached to the side of the bath tub (36). FIG. 5 shows the top view of the steamer manifold (27) with the inside hose communicating the steam for safety inserted into the frame of the shower door (33).

1) (canceled)

2) (canceled)

3) A flow through sauna steamer, comprising:
a heating element to generate steam;
a detachably connected manifold to supply said steam to a user;
a diverter detachably connected to a supply of water to divert said water to said heating element.

4) A flow through sauna steamer as in claim 1, wherein said heating element is detachably connected to a power source.

5) A flow through sauna steamer as in claim 1, wherein said diverter is connected to a faucet.

6) A flow through sauna steamer as in claim 1, wherein said diverter is connected to a showerhead.

7) A flow through sauna steamer as in claim 1, wherein said manifold to supply said steam is connected to a shower.

8) A flow through sauna steamer as in claim 1, wherein said diverter includes a solenoid bypass valve.

9) A flow through sauna steamer as in claim 1, wherein said manifold includes a first thermostat to control the temperature the water.

10) A flow through sauna steamer as in claim 1, wherein said manifold includes a flexible hose to supply said steam.

11) A flow through sauna steamer as in claim 1, wherein said manifold includes a second thermostat to control the power supplied to said heating element.

12) A flow through sauna steamer as in claim 1, wherein said diverter includes a knob for user to control the flow of said water.
